(19) United States
(12) Patent Application Publication
(10) Pub. No.: US 2014/0122183 A1
(43) Pub. Date: May 1, 2014

(54) PULSED-SURVEY SERVICE SYSTEMS AND METHODS

(71) Applicant: TINYHR INC., Seattle, WA (US)

(72) Inventor: David NIU, Seattle, WA (US)

(73) Assignee: TINYHR INC., Seattle, WA (US)

(21) Appl. No.: 14/030,924

(22) Filed: Sep. 18, 2013

Related U.S. Application Data
(60) Provisional application No. 61/720,340, filed on Oct. 30, 2012.

(51) Int. Cl. G06Q 30/02

(52) U.S. Cl. CPC G06Q 30/0203
USPC 705/7.32

(57) ABSTRACT

A pulsed-survey service may be provided by obtaining a question sequence including a number of survey questions, and determining a base survey-pulse rate, such as once per week, but no more frequent than once per day. During each pulse period, for each of a number of subscriber entities, a pulsed survey is performed. Each survey pulse poses and collects responses for at least one, but no more than ten percent of the survey questions. Both intra- and inter-entity benchmark statistics are determined for the pulsed-survey responses, and the statistics and survey results are provided for presentation to the subscriber entity via a survey-results interface.

### CROSS-REFERENCE TO RELATED APPLICATIONS

This application claims the benefit of priority to Provisional Patent Application No. 61/720,340; filed Oct. 30, 2012 under Attorney Docket No. TINH-2012002; titled PULSED EMPLOYEE-SURVEYS SYSTEMS AND METHODS; and naming inventor David NIU. The above-cited application is hereby incorporated by reference, in its entirety, for all purposes.

### FIELD

This disclosure is directed to the field of computer-mediated surveys, and more particularly, to automatically surveying business employees and other survey recipients on a periodic basis.

### BACKGROUND

Human resource management (“HRM”) refers to the management of an organization's workforce, or human resources. HRM is responsible for attracting, selecting, retaining, assessing, and/or rewarding employees, as well as overseeing organizational leadership and culture, and ensuring compliance with employment and labor laws.

Many large organizations have dedicated HRM personnel, whose job functions include monitoring employee sentiment and managing employee retention, all of which can contribute to maintaining a healthy and happy “culture” of a given organization. By contrast, many small- and medium-sized businesses lack dedicated HRM personnel. Frequently, the CEO or another manager may play multiple roles while running the company, including taking out the trash, ordering pizza, and acting as a one-person HRM department when necessary.

However, cultivating a healthy and happy company culture, maintaining employee satisfaction, and managing employee retention are at least as important in small- and medium-sized businesses as they are in larger organizations. Nonetheless, small- and medium-sized business managers may lack lightweight, frictionless, and easy-to-use solutions for monitoring and managing employee satisfaction, engagement, retention, and alignment with company values.

Similarly, many small- and medium-sized businesses may wish to use similar solutions for monitoring and managing satisfaction, engagement, retention, and alignment with company values among clients, customers, and/or other non-employees.

### BRIEF DESCRIPTION OF THE DRAWINGS

FIG. 1 illustrates a simplified pulsed survey system in which pulsed-survey server, Manager Device, Respondent Devices, and Client Entity B Device are connected to network.

FIG. 2 illustrates several components of an exemplary pulsed-survey server in accordance with one embodiment.

FIG. 3 illustrates a routine for providing a pulsed-survey service, such as may be performed by a pulsed-survey server in accordance with one embodiment.

FIG. 4 illustrates a subroutine for performing a survey pulse for a given client entity during a given pulse period from a given survey question set/sequence and an optional persistent survey question set, such as may be performed by a pulsed-survey server in accordance with one embodiment.

FIG. 5 illustrates a subroutine for obtaining pulsed-survey responses for a given survey question group for a given client entity during a given pulse period, such as may be performed by a pulsed-survey server in accordance with one embodiment.

FIG. 6 illustrates a subroutine for providing a survey-results interface for a given client entity and a given pulse period, such as may be performed by a pulsed-survey server in accordance with one embodiment.

FIG. 7 illustrates a subroutine for providing a results display for a given quantitative survey question and a given client entity, such as may be performed by a pulsed-survey server in accordance with one embodiment.

FIG. 8 illustrates a subroutine for providing a results display for a non-quantitative survey question, such as may be performed by a pulsed-survey server in accordance with one embodiment.

FIG. 9 illustrates an exemplary pulsed-survey interface posing survey questions to a respondent, in accordance with one embodiment.

FIG. 10 illustrates an exemplary survey-responses dashboard interface, in accordance with one embodiment.

FIG. 11 illustrates an exemplary anonymized-communication interface enabling anonymized communication with a given respondent who provided a non-attributed, non-quantitative response to a given survey question, in accordance with one embodiment.

### DESCRIPTION

In various embodiments as described herein, various techniques may be employed to pose survey questions to employees, clients, and/or customers of multiple business entities in a “pulsed” manner, such that over time, an evolving picture of survey-recipient sentiment and happiness with respect to a business entity may be collected without unduly imposing on employees at any one point in time.

In one commercial embodiment, a CEO or other manager may sign up for a pulsed-survey service and invite the company's employees, clients, and/or customers to participate. At a “base” pulse-rate (e.g., once per week), the survey recipients are asked to anonymously answer a handful of sentiment questions collectively designed to elicit responses indicating their sentiments with respect to the business entity. For example, when the survey recipients are employees of a business entity, sentiment questions may elicit responses indicating how happy they are; whether they can articulate the company's vision, mission, and cultural values; how valued they feel; what they like and dislike about their jobs; areas where they see room for improvement; and other such sentiments.

Generally, sentiment questions are posed only once or are repeated only infrequently and/or not on a fixed cycle. However, in one commercial embodiment, one or a small number of questions may be repeated on a periodic sub-cycle (e.g., once per month or every other week, if the “base” pulse rate is once per week). For example, when the survey recipients are employees of a business entity, a sub-cyclic question asks the employees how happy they are, such that happiness trends can be observed over time in a given company. Similarly, if the survey recipients are outside the business entity (e.g., they are clients, customers, or the like), a sub-cyclic question may ask the recipients how happy they are with the goods and/or services provided by the business entity.

Additionally, in one embodiment, the survey-recipients can highlight co-workers and/or employees of the business entity for anonymous or attributed praise and/or provide anonymous suggestions to management.

Additional details, embodiments, and alternatives are described below.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

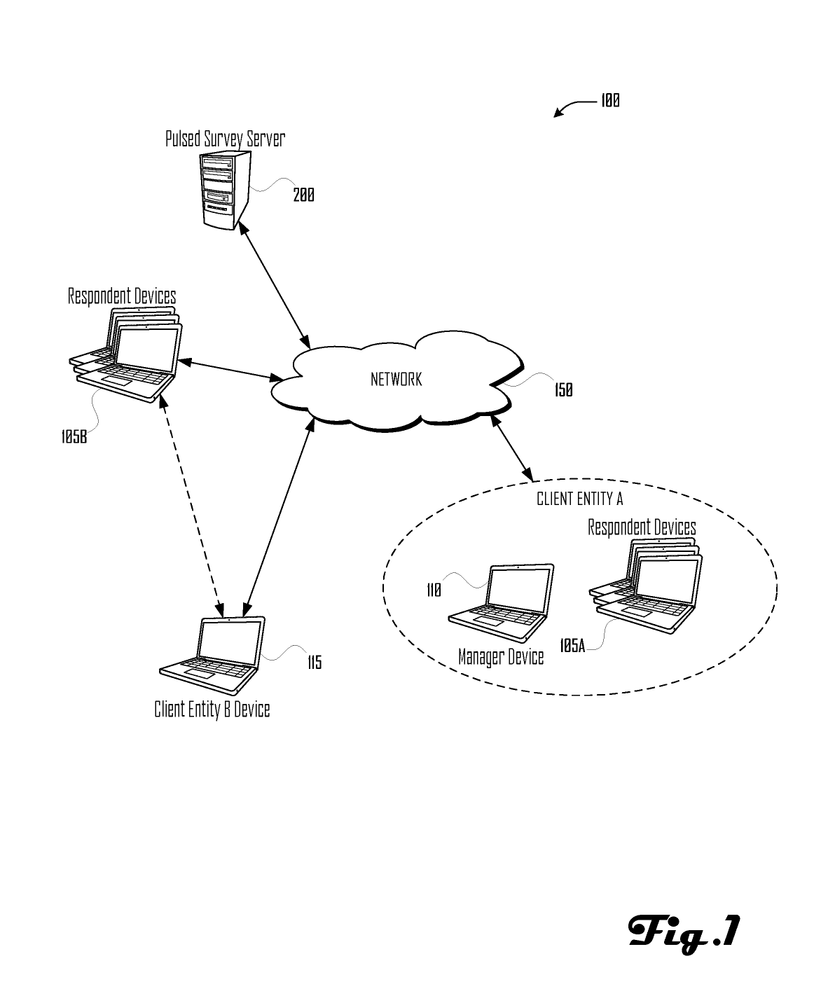

FIG. 1 illustrates a simplified pulsed survey system in which pulsed-survey server 200, Manager Device 110, Respondent Devices 105A-B, and Client Entity B Device 115 are connected to network 150.

In various embodiments, network 150 may include the Internet, a local area network (“LAN”), a wide area network (“WAN”), and/or other data network.

In various embodiments, manager, client, and respondent devices may include desktop PCs, mobile phones, laptops, tablets, or other computing devices that are capable of connecting to network 150 and consuming services such as those described herein.

In many embodiments, additional business entities may be represented within the system, and each business entity may include more employee, respondent, and/or manager devices than are displayed in FIG. 1.

In various embodiments, additional infrastructure (e.g., cell sites, routers, gateways, firewalls, and the like), as well as additional devices may be present. Further, in some embodiments, the functions described as being provided by some or all of pulsed-survey server 200 may be implemented via various combinations of physical and/or logical devices. However, it is not necessary to show such infrastructure and implementation details in FIG. 1 in order to describe an illustrative embodiment.

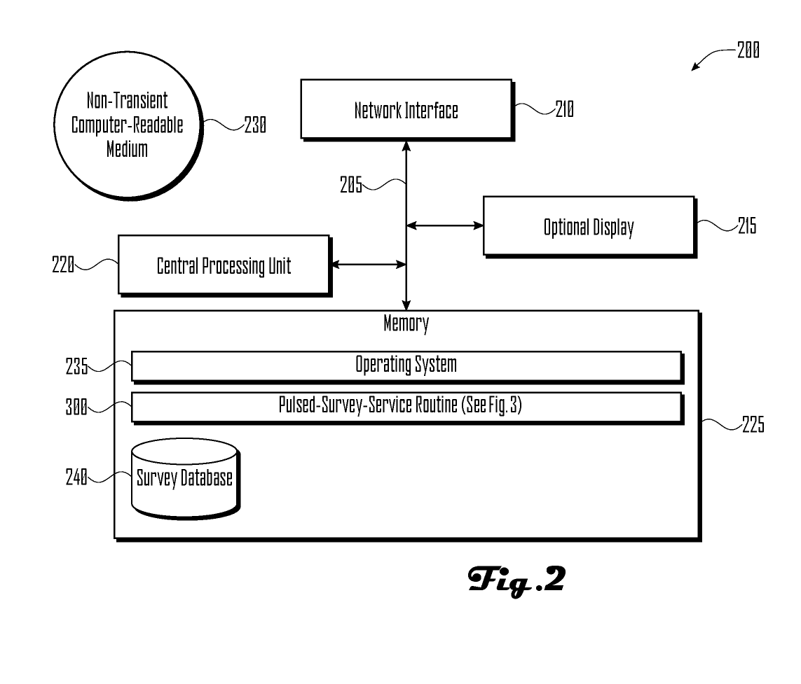

FIG. 2 illustrates several components of an exemplary pulsed-survey server in accordance with one embodiment. In some embodiments, pulsed-survey server 200 may include many more components than those shown in FIG. 2. However, it is not necessary that all of these generally conventional components be shown in order to disclose an illustrative embodiment.

In various embodiments, pulsed-survey server 200 may comprise one or more physical and/or logical devices that collectively provide the functionalities described herein. In some embodiments, pulsed-survey server 200 may comprise one or more replicated and/or distributed physical or logical devices.

In some embodiments, pulsed-survey server 200 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Pulsed-survey server 200 includes a bus 205 interconnecting several components including a network interface 210, an optional display 215, a central processing unit 220, and a memory 225.

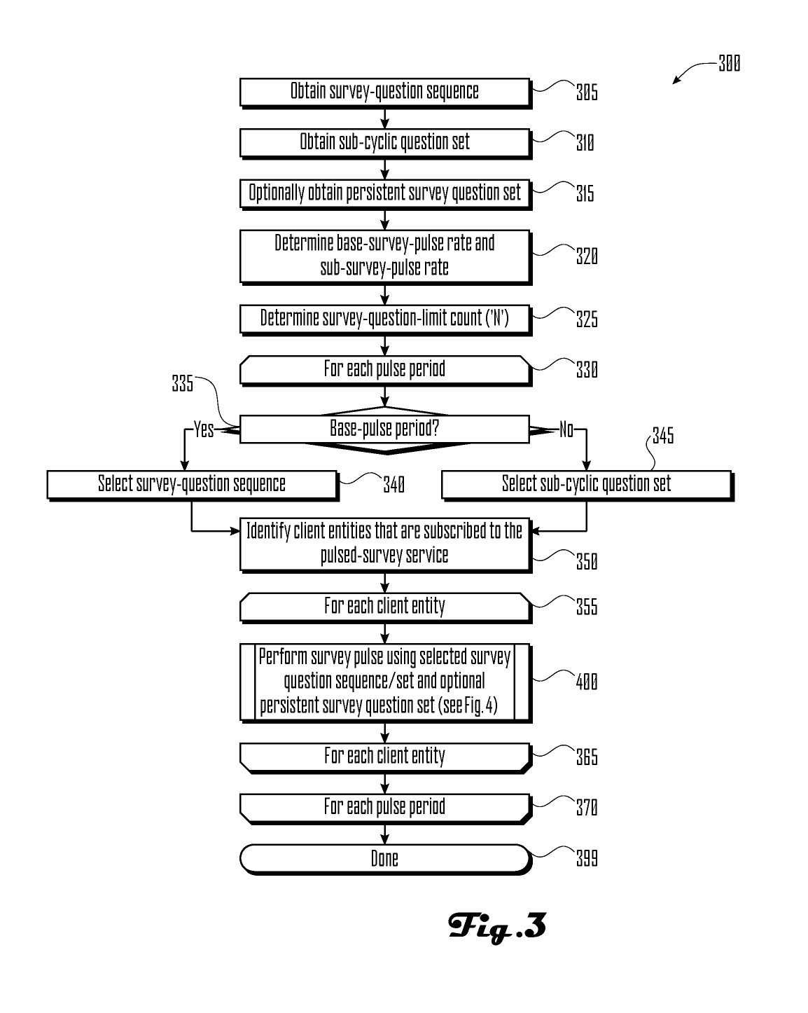

Memory 225 generally comprises a random access memory (“RAM”), a read only memory (“ROM”), and a permanent mass storage device, such as a disk drive. The memory 225 stores program code for a routine 300 for providing a pulsed-survey service (see FIG. 3, discussed below). In addition, the memory 225 also stores an operating system 235

These and other software components may be loaded into memory 225 of pulsed-survey server 200 using a drive mechanism (not shown) associated with a non-transient computer-readable medium 230, such as a floppy disc, tape, DVD/CD-ROM drive, memory card, or the like.

Memory 225 also includes survey database 240. In some embodiments, pulsed-survey server 200 may communicate with survey database 240 via network interface 210, a storage area network (“SAN”), a high-speed serial bus, and/or via the other suitable communication technology.

In some embodiments, survey database 240 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

FIG. 3 illustrates a routine 300 for providing a pulsed-survey service, such as may be performed by a pulsed-survey server 200 in accordance with one embodiment.

In block 305, routine 300 obtains a survey-question sequence comprising at least ten survey questions. Generally, survey questions within the survey-question sequence (like most survey questions) are not repeated or are repeated only infrequently and irregularly.

For example, in one embodiment, the survey-question sequence may include survey questions such as some or all of the following when employees are the intended survey recipients:

1. From a scale of 1-10, how happy are you at work?

2. Can you recite your organization's vision, mission, and cultural values?

3. What's one thing the company should continue doing to be more successful?

4. What's one thing the company should start doing to be more successful?

5. What's one thing the company should stop doing to be more successful?

6. From a scale of 1-10, how likely will you still be working here in one year?

7. From a scale of 1-10, how happy are you at work?

8. On a scale of 1-10, how valued do you feel at work?

9. On a scale of 1-10, how would you rate your company's future?

10. Who do you consider the company's most valuable player/contributor?

11. From a scale of 1-10, how happy are you at work?

12. What one thing would you implement to improve the company's culture?

Other examples of survey questions that may be included when surveying employees include survey questions such as some or all of the following.
What are three words you'd use to describe our culture?
What do you think is the company's biggest weakness?
Who do you consider the company's rookie of the year?
From a scale of 1-10, how likely will you be working here in three years?
What is the #1 issue you would change at the company?
What motivates you?
Do you feel that your manager has clearly defined your roles and responsibilities for the next quarter?
Aside from salary, what do you feel is the most valuable benefit of working at your company?
How knowledgeable are you about what others are working on who are outside of your department
From a scale of 1-10, how transparent do you feel management is?
If you had to describe your company as an animal, what animal would it be?
If you had to write your company's fortune for next year, what would you write for the fortune cookie?
Tell me one thing about the company that everyone knows/that everyone should know/that everyone but the CEO should know?
If you had to write your own fortune about your career here, what would you write/how long would you be here/why would you leave?
What is one thing that drives you crazy daily that you wish could be changed at this company?
How can management better improve communications?
From a scale of 1-10, how enthusiastically would you refer a friend to work here?

Other embodiments may use more, fewer, and/or different survey questions that are oriented towards eliciting sentiments about a business entity from a certain type of recipient (e.g., employees, clients, and/or customers).

In block 310, routine 300 obtains a sub-cyclic question set comprising at least one sub-cyclic survey question. An at least one sub-cyclic survey question is one that (unlike most survey questions) is repeated every ‘M’ pulse periods (where ‘M’ is greater than one). Consequently, at least one sub-cyclic survey questions may be used to track long-term trends on a given question.

For example, in some embodiments, an at least one sub-cyclic survey question may be chosen to elicit responses that gauge respondents' overall happiness, engagement, and/or satisfaction with respect to a business entity. In one embodiment, a “happiness” survey question such as “From a scale of 1-10, how happy are you at work?” may be repeated on a four-week cycle, or “From a scale of 1-10, how happy are you with Company X?” may be repeated on a four-month cycle.

In block 315, routine 300 optionally obtains a persistent survey question set comprising at least one persistent survey question that is posed during every pulse period. Typically, a persistent survey question may provide the respondent with an opportunity to provide additional information related to a survey question, to provide free-form suggestions, to identify an employee of the business entity for recognition, or the like.

For example, in many cases, a non-persistent survey question may ask the respondent to rate something on a scale of 1-10, select from a bounded set of discrete options (e.g., select from statements A-D the statement that most closely matches your sentiment), answer yes or no, or otherwise provide a quantitative response. In some embodiments, an optional persistent survey question may also be posed, allowing the respondent to explain or comment on his or her quantitative answer in free-form text.

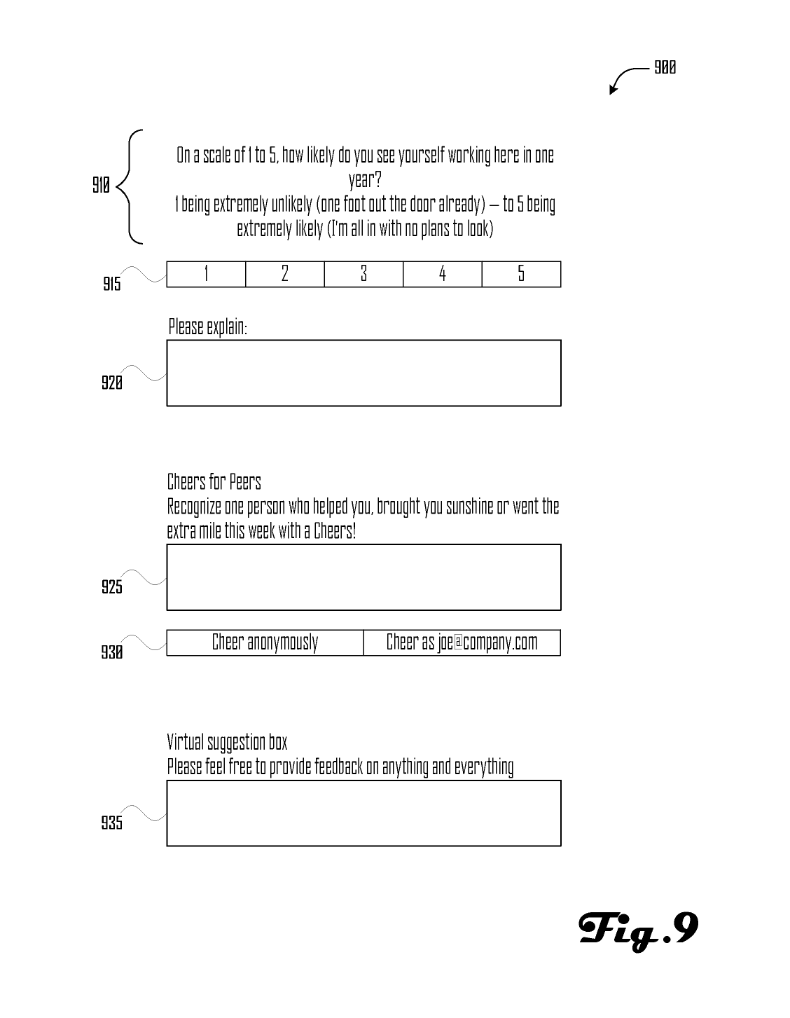

In some embodiments, in block 315, routine 300 may obtain a small number of survey questions that provide the respondent with an opportunity to provide certain information in all or most survey pulses. For example, in one embodiment, routine 300 may obtain a minimal set of optional survey questions including survey questions that allow the respondent to praise an employee of a business entity and/or to make suggestions or provide feedback on any topic. See, e.g., optional-recognition control 925 and suggestion control 935 of pulsed-survey interface 900 (see FIG. 9, discussed below).

In block 320, routine 300 determines a base-survey-pulse rate corresponding to a plurality of base pulse periods, the base-survey-pulse rate being no more frequent than one pulse period per day, and a sub-survey-pulse rate corresponding to a plurality of sub-pulse periods, the sub-survey-pulse rate being no more than half as frequent as the base-survey-pulse rate.

For example, in one embodiment, survey questions in the survey-question sequence may be pulsed at a base rate of once per week. In other embodiments, other base-survey-pulse rates may be employed. In many embodiments, base-survey-pulse rates should be high enough to encourage respondents to habitually provide responses, but low enough to not unduly interfere with respondent productivity.

In block 325, routine 300 determines a limit on the number of survey questions to pose during any pulse period. In one embodiment, survey pulses may each include only one survey question from the survey-question sequence (i.e., in such an embodiment, survey-question-limit count (‘N’) may be one). In other embodiments, survey pulses may include more than one survey question, although a survey pulse should not include more than ten percent of the survey questions in the survey-question sequence.

Beginning in opening loop block 330, routine 300 processes each pulse period in turn. In decision block 335, routine 300 determines whether the current pulse period is a base-pulse period (or a sub-survey-pulse rate). If so, then routine 300 proceeds to block 340. Otherwise (if the current pulse period is a sub-pulse period), then routine 300 proceeds to block 345.

For example, if the at least one sub-cyclic survey questions are repeated every fourth cycle, and it has been three cycles since the current pulse period was surveyed according to the at least one sub-cyclic survey questions, then in decision block 335, routine 300 may determine that the current pulse period is due to be surveyed according to the at least one sub-cyclic survey questions.

In block 340, routine 300 selects the survey-question sequence obtained in block 305 to be used when performing a survey pulse during the current pulse period. In block 345, routine 300 selects the sub-cyclic question set obtained in block 310 to be used when performing a survey pulse during the current pulse period.

In block 350, routine 300 identifies a multiplicity of client entities that are subscribed to the pulsed-survey service. Typically, a manager (or HR personnel) may indicate his or her desire to survey sentiments regarding the business entity from employees, clients, and/or customers by signing up for a service provided by pulsed-survey server 200. The manager typically also provides a list of email addresses or otherwise provides electronic contact information for a number of employees, clients, and/or customers who should be surveyed on a pulsed basis.

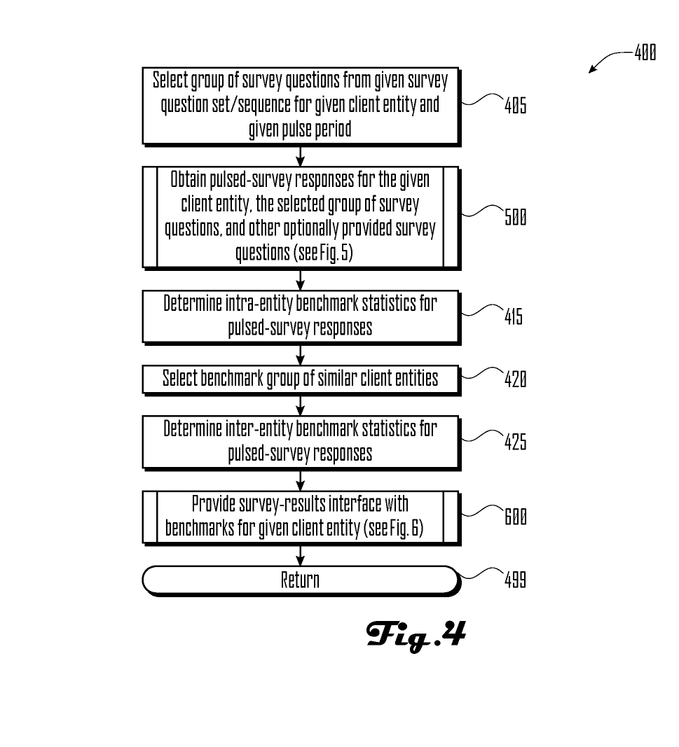

Beginning in opening loop block 355, routine 300 processes each client entity in turn. In subroutine block 400, routine 300 calls subroutine 400 (see FIG. 4, discussed below) to perform a survey pulse for the current client entity and the current pulse period using the survey question sequence selected in block 340 or the survey question or set selected in block 345.

In ending loop block 365, routine 300 iterates back to opening loop block 355 to process the next client entity, if any. In ending loop block 370, routine 300 iterates back to opening loop block 330 to process the next pulse period, if any. Routine 300 ends in ending block 399.

FIG. 4 illustrates a subroutine 400 for performing a survey pulse for a given client entity during a given pulse period from a given survey question set/sequence and an optional persistent survey question set, such as may be performed by a pulsed-survey server 200 in accordance with one embodiment.

In block 405, subroutine 400 selects a survey group including at least one survey question from the given survey question set/sequence, but including no more than ten percent of the survey questions of the given survey question set/sequence. In some embodiments, such as when given a survey-question sequence, selecting the survey group may include determining a position within the given survey question set/sequence for the given client entity, and selecting at least one survey question (but no more then ten percent) according to the determined position.

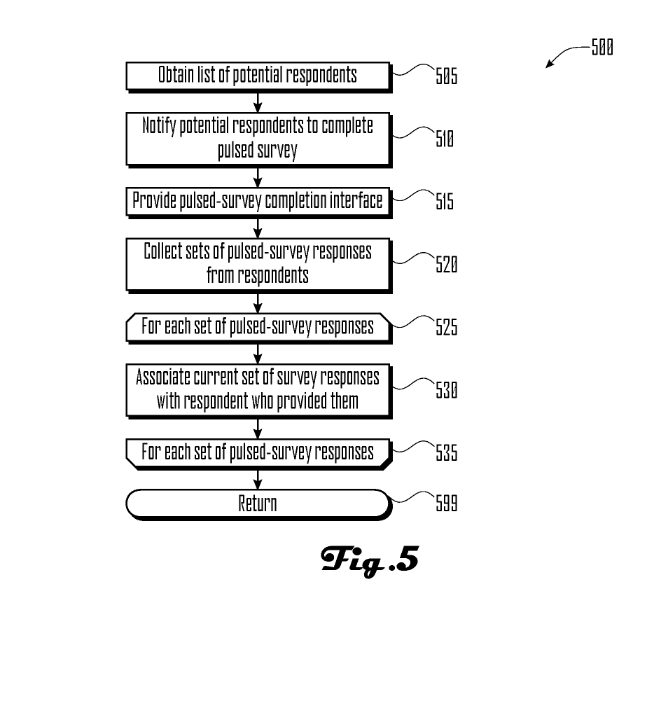

In subroutine block 500, subroutine 400 calls subroutine 500 (see FIG. 5, discussed below) to pose and obtain pulsed-survey responses for the given client entity for the selected group of survey questions and any optionally provided persistent survey questions.

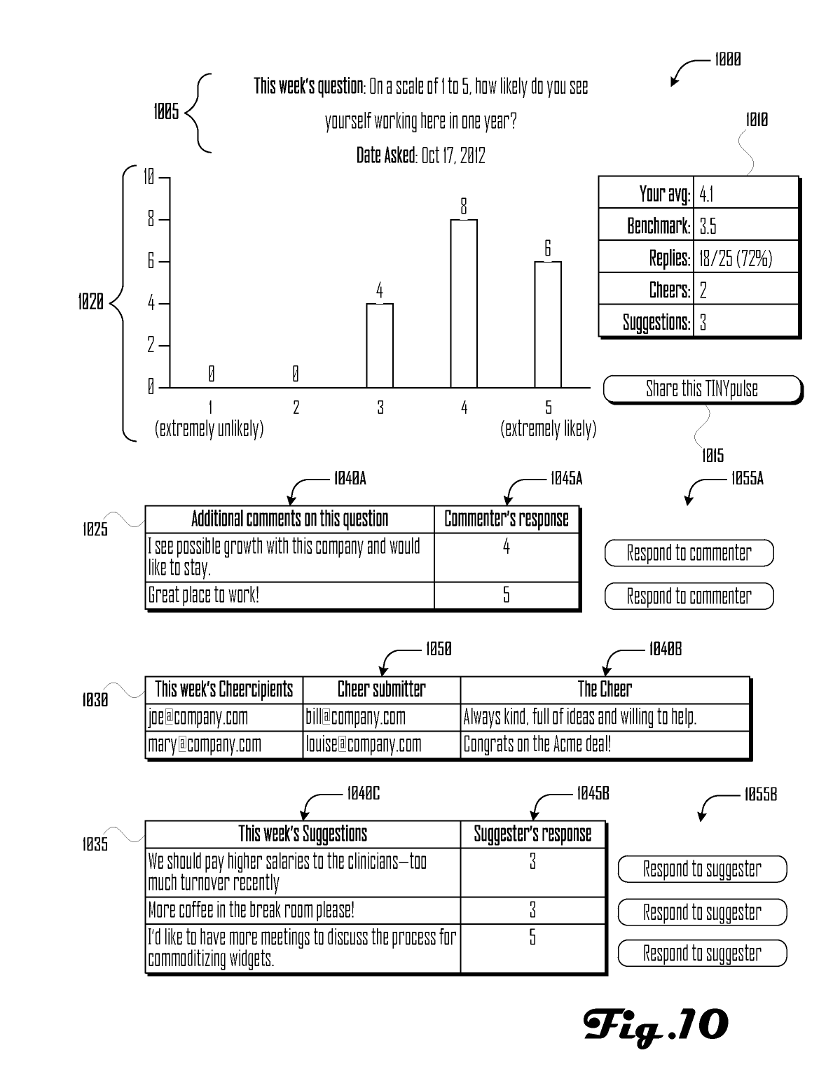

In block 415, subroutine 400 determines intra-entity benchmark statistics for the pulsed-survey responses obtained in subroutine block 500. See, e.g., survey-question statistical summary element 1010 (“Your avg”) of survey-responses dashboard interface 1000 (see FIG. 10, discussed below). For example, in one embodiment, subroutine 400 may determine and present an average quantitative response provided by respondents associated with the given client entity. In other embodiments, subroutine 400 may determine additional and/or different statistical measures, such as an arithmetic mean, a median, a mode, and/or other like statistical measures.

In block 420, subroutine 400 selects a “benchmark” group of business entities that share one or more similar traits with the given client entity. For example, in one embodiment, the “benchmark” group may include business entities that are of a similar size to the given client entity, that are located in a similar geographic region to the given client entity, that are in a similar business segment as the given client entity, and/or that are similar in some other respect. In other embodiments, a manager of the given client entity may provide a selection of some or all business entities to be included in the “benchmark” group.

In block 425, subroutine 400 determines inter-entity benchmark statistics for the pulsed-survey responses obtained in subroutine block 500. See, e.g., survey-question statistical summary element 1010 (“Benchmark”) of survey-responses dashboard interface 1000 (see FIG. 10, discussed below). For example, in one embodiment, subroutine 400 may determine and present an average quantitative response provided by respondents associated with the given client entity and among the “benchmark” group. In other embodiments, subroutine 400 may determine additional and/or different statistical measures, such as an arithmetic mean, a median, a mode, and/or other like statistical measures.

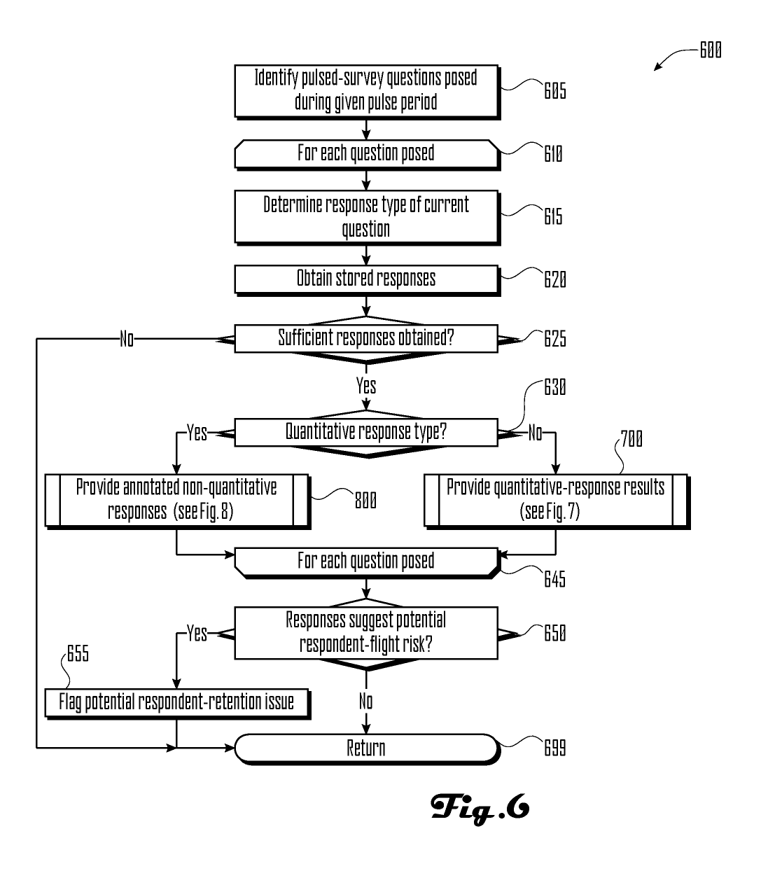

In subroutine block 600, subroutine 400 calls subroutine 600 (see FIG. 6, discussed below) to provide for presentation to the given client entity a survey-results interface including an intra-entity benchmark statistic, an inter-entity benchmark statistic, and a plurality of survey responses, said plurality of obtained survey responses being unattributable to a plurality of respondents. See, e.g., survey-responses dashboard interface 1000 (see FIG. 10, discussed below).

Subroutine 400 ends in ending block 499, returning to the caller.

FIG. 5 illustrates a subroutine 500 for obtaining pulsed-survey responses for a given survey question group for a given client entity during a given pulse period, such as may be performed by a pulsed-survey server 200 in accordance with one embodiment.

In block 505, subroutine 500 obtains a list identifying potential respondents associated with the business entity, which may in various embodiments be employees, clients, and/or customers. Typically such a list may have been provided by a manager of the business entity.

In block 510, subroutine 500 notifies the potential respondents that they are asked to complete a survey. For example, in one embodiment, subroutine 500 may send or cause to be sent emails, text messages, instant messages, direct messages, or other like electronic messages to the potential respondents. In some embodiments, the survey-availability notification may include (e.g., embedded in a link to a survey-completion interface) an identification code by which a given respondent's responses can be associated with that particular respondent. In some embodiments, a time-window for providing responses may close when the next pulse-period begins. In such embodiments, subroutine 500 may send periodic reminders to respondents who have not provided responses before a predetermined amount of time has passed (e.g., within five days from receiving the initial notification, when only two days remain until the time window closes, or the like).

In block 515, subroutine 500 provides an interface via which the potential respondents can submit responses to the given survey question set/sequence. See, e.g., pulsed-survey interface 900 (see FIG. 9, discussed below).

In block 520, subroutine 500 collects sets of pulsed-survey responses from some of all of the potential respondents (via the interface provided in block 515). Beginning in opening loop block 525, subroutine 500 processes each set of pulsed-survey responses in turn.

In block 530, subroutine 500 identifies which respondent provided the current set of pulsed-survey responses and associates the current set of pulsed-survey responses with the identified respondent (e.g., in survey database 240).

In ending loop block 535, subroutine 500 iterates back to opening loop block 525 to process the next set of pulsed-survey responses, if any.

Subroutine 500 ends in ending block 599, returning to the caller.

FIG. 6 illustrates a subroutine 600 for providing a survey-results interface for a given client entity and a given pulse period, such as may be performed by a pulsed-survey server 200 in accordance with one embodiment.

In block 605, subroutine 600 identifies one or more survey questions that were posed to employees, clients, and/or customers of the given client entity during the given pulse period. In various embodiments, the one or more survey questions may include one or more optional and/or persistent survey questions.

Beginning in opening loop block 610, subroutine 600 processes each survey question identified in block 605 in turn.

In block 615, subroutine 600 determines a response type associated with the current survey question. In some embodiments, “quantitative”-type survey questions may ask a respondent to, for example, rate something on a scale of 1-10, select from a bounded set of discrete options (e.g., select from statements A-D the statement that most closely matches your sentiment), answer yes or no, or otherwise provide a quantitative response. Contrastingly, non-quantitative-type questions may ask a respondent to, for example, provide free-form text or other non-quantitative input.

In block 620, subroutine 600 obtains stored responses (e.g. from survey database 240) that have been collected from one or more respondents to the current survey question.

In decision block 625, subroutine 600 determines whether a sufficient quantity of responses have been collected at the current point in time. In some embodiments, to preserve respondent anonymity (particularly if the respondents are employees of a smaller company), subroutine 600 may provide a survey-results “dashboard” only after a certain quantity of responses (e.g., five responses) have been collected. In other embodiments, subroutine 600 may determine whether to display results on a question-by-question basis, assessing each individual question's response count against a predetermined threshold. If such a response-quantity threshold has not been met, then subroutine 600 may proceed to ending block 699, possibly providing a notification that an insufficient quantity of responses have been obtained. Otherwise, if a sufficient quantity of responses has been obtained, subroutine 600 proceeds to decision block 630.

In decision block 630, subroutine 600 determines whether the response-type of the current survey question (as determined in block 615) is quantitative or non-quantitative. If the current survey question is quantitative, then subroutine 600 proceeds to call subroutine 800. Otherwise, subroutine 600 proceeds to call subroutine 700.

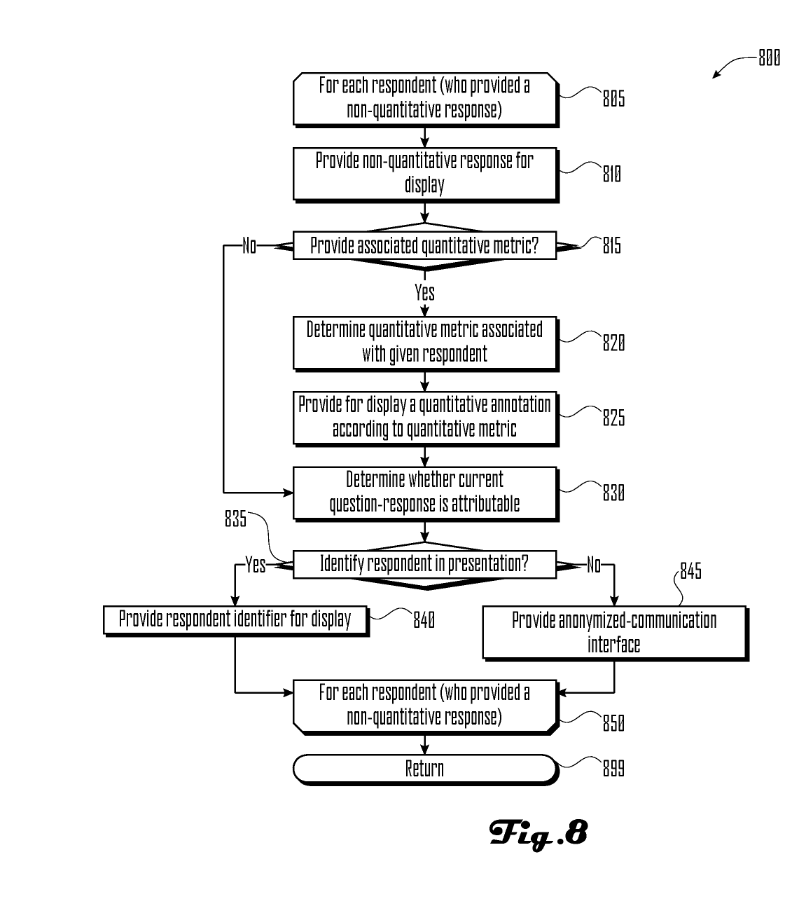

In subroutine block 800, subroutine 600 calls subroutine 800 (see FIG. 8, discussed below) to provide a results display for the current non-quantitative survey question.

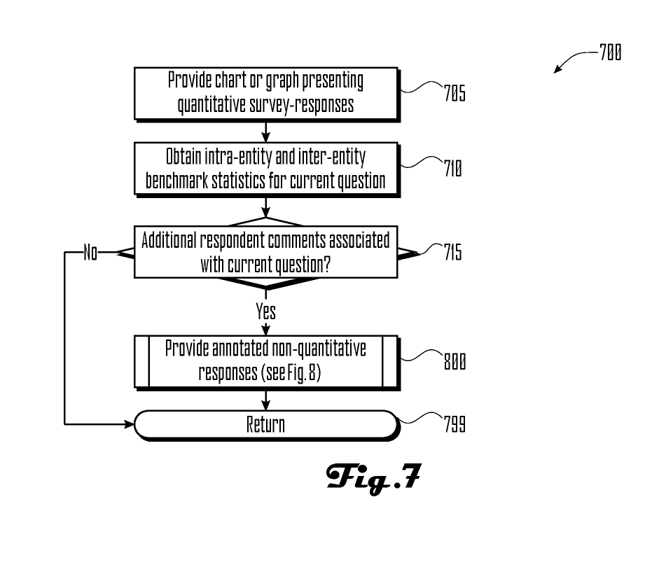

In subroutine block 700, subroutine 600 calls subroutine 700 (see FIG. 7, discussed below) to provide a results display for the current quantitative survey question.

In ending loop block 645, subroutine 600 iterates back to opening loop block 610 to process the next survey question identified in block 605, if any.

In decision block 650, subroutine 600 determines whether the responses obtained in block 620 suggest that one or more respondents are a potential risk to sever their relationships with the business entity in the foreseeable future, such as by resigning (in the case of employee-respondents) or finding another vendor to provide goods and/or services provided by the business entity (in the case of client- or customer-respondents).

For example, in some embodiments managers of business entities may from time to time identify certain respondents who had previously been sent one or more surveys, but who have since have severed their relationships with the business entities. Once a statistically significant quantity of severed-relationship respondents have been identified (across one or more business entities), the survey-responses provided by the severed-relationship respondents may be analyzed to identify patterns that may be predictive of respondents who are likely to sever their relationships with business entity. For example, in some cases, survey responses that indicate low satisfaction and/or engagement may be predictive. In other cases, a decrease in the quantity and/or kind of survey-responses provided may also be predictive.

If in decision block 650, subroutine 600 determines that one or more respondents are a potential risk to sever their relationships with business entity in the foreseeable future, then subroutine 600 proceeds to block 655.

In block 655, subroutine 600 modifies the dashboard presentation to indicate to the viewing manager that one or more respondents have provided survey responses indicating that they may sever their relationship with the business entity in the foreseeable future. In some embodiments, such as when the respondents are employees at risk of quitting, the respondents are not identified to the manager by name or otherwise.

Subroutine 600 ends in ending block 699.

FIG. 7 illustrates a subroutine 700 for providing a results display for a given quantitative survey question and a given client entity, such as may be performed by a pulsed-survey server 200 in accordance with one embodiment.

In block 705, subroutine 700 provides to a remote manager a chart or graph presenting quantitative responses to quantitative survey questions, the responses having been provided by respondents corresponding to the given client entity. See, e.g., quantitative-responses chart 1020 of survey-responses dashboard interface 1000 (see FIG. 10, discussed below).

In block 710, subroutine 700 obtains intra-entity and inter-entity benchmark statistics for current question. See, e.g., block 415 and block 425 (see FIG. 4, discussed above).

In decision block 715, subroutine 700 determines whether the respondents who provided quantitative responses to quantitative survey questions also provided comments or other non-quantitative responses associated with their quantitative responses.

In subroutine block 800, subroutine 700 calls subroutine 800 (see FIG. 8, discussed below) to provide annotated non-quantitative responses associated with the quantitative responses to the quantitative survey question. See, e.g., anonymized-communication element 1130 of survey-responses dashboard interface 1000 (see FIG. 10, discussed below).

Subroutine 700 ends in ending block 799, returning to the caller.

FIG. 8 illustrates a subroutine 800 for providing a results display for a non-quantitative survey question, such as may be performed by a pulsed-survey server 200 in accordance with one embodiment.

Beginning in opening loop block 805, subroutine 800 processes each respondent who provided a non-quantitative response in turn.

In block 810, subroutine 800 provides to a remote manager the non-quantitative response provided by the current respondent. See, e.g., non-quantitative response column 1140A-C of survey-responses dashboard interface 1000 (see FIG. 10, discussed below).

In decision block 815, subroutine 800 determines whether a quantitative metric is associated with the non-quantitative survey question, and if so, whether to provide the quantitative metric to the remote manager. For example, in one embodiment, a certain type of non-quantitative survey question (e.g., a survey question asking the respondent to comment on a quantitative survey question) may correspond to a quantitative survey question, and such a non-quantitative survey question may customarily be presented along with an annotation indicating the respondent's answer to the corresponding quantitative survey question.

If in decision block 815, subroutine 800 determines that a quantitative metric is associated with the non-quantitative survey question, then subroutine 800 proceeds to block 820.

In block 820, subroutine 800 determines a quantitative metric associated with the non-quantitative survey question and the current respondent. For example, in one embodiment, the determined quantitative metric may be the value provided by the respondent in response to the non-quantitative survey question.

In block 825, subroutine 800 provides for display to the remote manager a quantitative annotation corresponding to the quantitative metric determined in block 820. See, e.g., quantitative annotation columns 1145A-B of survey-responses dashboard interface 1000 (see FIG. 10, discussed below).

In block 830, subroutine 800 determines whether the response provided by the current respondent is attributable, such that the current respondent may be identified to the remote manager. For example, in most cases, survey question responses (quantitative or otherwise) are kept confidential (i.e., not-attributable), such that the identity of the respondent is never revealed to a remote manager. However, some survey questions may be optionally or selectably non-anonymous or attributable. See, e.g., optional-recognition control 925 of pulsed-survey interface 900 (see FIG. 9, discussed below).

In decision block 835, subroutine 800 determines, based on the attribution determination made in block 830, whether to present to the remote manager identifying information associated with the respondent. If subroutine 800 determines to present identifying information, then subroutine 800 proceeds to block 840. Otherwise, subroutine 800 proceeds to block 845.

In block 840, subroutine 800 provides for display to the remote manager identifying information (e.g., a name, an email address, or other respondent identifier) associated with the current respondent. See, e.g., respondent-identifier column 1050 of survey-responses dashboard interface 1000 (see FIG. 10, discussed below).

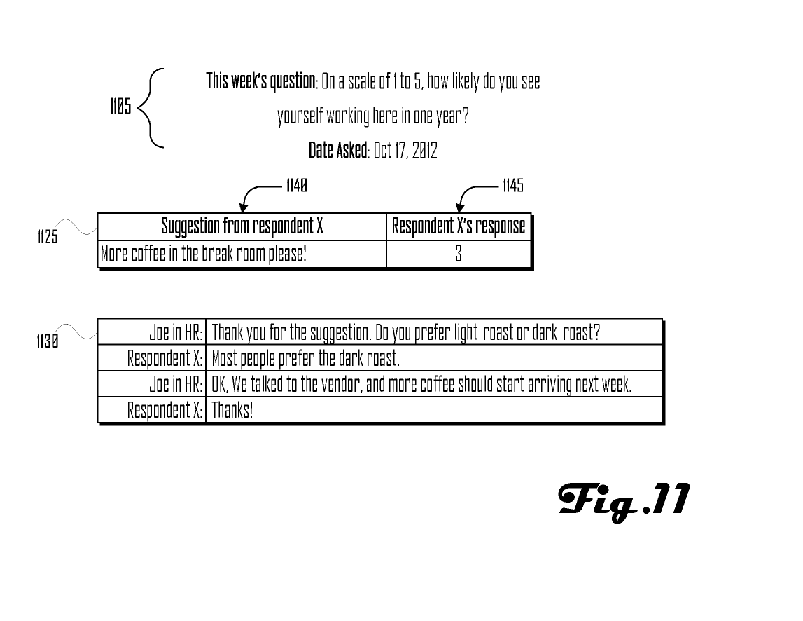

In block 845, subroutine 800 provides an anonymized-communication interface enabling anonymized communication with some or all of a plurality of respondents who provided a plurality of comments. See, e.g., anonymized-communication interface 1100 (see FIG. 11, discussed below).

In ending loop block 850, subroutine 800 iterates back to opening loop block 805 to process the next respondent who provided a non-quantitative response, if any.

Subroutine 800 ends in ending block 899, returning to the caller.

FIG. 9 illustrates an exemplary pulsed-survey interface 900 posing survey questions to a respondent, in accordance with one embodiment.

Survey-question display 910 poses a survey question to a respondent.

Quantitative-response controls 915 enable the respondent to respond to provide a quantitative response to the survey question posed by survey-question display 910.

Optional-explanation control 920 enables the respondent to provide free-form text to explain and/or comment on his or her answer to the survey question posed by survey-question display 910.

Optional-recognition control 925 enables the respondent to provide free-form text to praise or otherwise recognize a co-worker or other individual. In other embodiments, optional-recognition control 925 may be further associated with a control (not shown) enabling the respondent to select among a list of potentially recognizable individuals.

Attribution control 930 enables the respondent to indicate whether any praise provided via optional-recognition control 925 should be attributed to the respondent (here, “joe@company.com”) or whether any such praise should remain anonymous.

Suggestion control 935 enables the respondent to make suggestions or provide feedback on any topic.

FIG. 10 illustrates an exemplary survey-responses dashboard interface 1000, in accordance with one embodiment. In the illustrated example, the respondents are employees of the business entity. In other embodiments, the respondents may be employees, clients, and/or customers associated with the business entity.

Survey-question element 1005 presents a survey question that was posed to respondents associated with a business entity on an indicated date.

Survey-question statistical summary element 1010 presents a plurality of statistical measures associated with the survey questions posed on the indicated date. In the illustrated example, survey-question statistical summary element 1010 presents an average of quantitative results provided by respondents associated with a given business entity, as well as a “benchmark” average of quantitative results provided to the same survey question by respondents associated with a set of similar business entities. Survey-question statistical summary element 1010 also includes a response-rate percentage and counts indicating how many respondents provided responses to two optional survey questions.

Results-sharing control 1015 enables the manager who is viewing the survey-responses dashboard interface 1000 to create a “sharing interface” (not shown) including some or all of the information presented in survey-responses dashboard interface 1000 for exposure to respondents, the public, and/or others.

Quantitative-responses chart 1020 presents a graphical summary of quantitative responses provided by respondents of the given business entity to the survey question indicated by survey-question element 1105. In the illustrated example, quantitative-responses chart 1020 indicates that zero respondents provided quantitative responses of ‘1’ and ‘2’, four respondents provided a quantitative response of ‘3’, eight respondents provided a quantitative response of ‘4’, and six respondents provided a quantitative response of ‘5’.

Annotated non-quantitative responses elements 1025A-C present comments or other non-quantitative responses that were provided by some or all of the respondents (i.e., respondents who provided the quantitative responses presented in quantitative-responses chart 1020). In some embodiments, the comments are annotated with the quantitative response values provided by the commenter. For example, as illustrated, annotated non-quantitative responses elements 1025 indicates that the commenter who provided the comment, “Great place to work!”, also provided a quantitative response of ‘5’ to the quantitative survey question.

In non-quantitative response columns 1040A-C, individual non-quantitative responses provided by respondents are displayed. In quantitative annotation columns 1045A-B, individual quantitative annotations corresponding to non-quantitative responses are displayed. In respondent-identifier column 1050, respondent-identifying information is displayed.

Anonymous-communication control 1055A-B enables the manager who is viewing the survey-responses dashboard interface 1000 to create an anonymous-communication interface enabling anonymized communication with a respondent. See, e.g., anonymized-communication interface 1100 (see FIG. 11, discussed below).

FIG. 11 illustrates an exemplary anonymized-communication interface 1100 enabling anonymized communication with a given respondent who provided a non-attributed, non-quantitative response to a given survey question, in accordance with one embodiment.

Survey-question element 1105 presents a survey question that was posed to the given respondent associated with a business entity on an indicated date.

Annotated non-quantitative response element 1125 presents comments or other non-quantitative responses that were provided by the given respondent. In some embodiments, the comments are annotated with the quantitative response values provided by the commenter.

Anonymized-communication element 1130 enables communication between a manager and an anonymous respondent. In non-quantitative response column 1140, an individual non-quantitative response provided by the given respondent is displayed. In quantitative annotation columns 1145, an individual quantitative annotation corresponding to non-quantitative response is displayed.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A server-device-implemented method for providing a pulsed-survey service, the method comprising:
obtaining, by said server device, a question sequence comprising at least ten survey questions;
determining a base survey-pulse rate corresponding to a plurality of base pulse periods, said base survey-pulse rate being no more frequent than one pulse period per day;
performing, by said server device, steps a-b during each current base pulse period of said plurality of base pulse periods:
a. identifying a multiplicity of client entities that are subscribed to said pulsed-survey service during each current base pulse period;
b. performing sub-steps i-vi for each current client entity of said multiplicity of client entities:
i. determining a position within said question sequence for each current client entity;
ii. selecting a survey group comprising at least one survey question from said question sequence according to said determined position, but said survey group comprising no more than ten percent of said at least ten survey questions of said question sequence;
iii. obtaining, from a plurality of respondents that are associated with each current client entity, a plurality of survey responses corresponding to said at least one selected survey question of said survey group;
iv. determining an intra-entity benchmark statistic corresponding to said plurality of obtained survey responses;
v. determining an inter-entity benchmark statistic corresponding to said plurality of obtained survey responses and a plurality of other-entities responses to said at least one selected survey question that were provided by a plurality of other-entities respondents associated with a benchmark group of other client entities that are similar in some respect to each current client entity; and
vi. providing for presentation to each current client entity a survey-results interface comprising said intra-entity benchmark statistic, said inter-entity benchmark statistic, and said plurality of obtained survey responses, said plurality of obtained survey responses being unattributable to said plurality of respondents.

2. The method of claim 1, further comprising:
obtaining a sub-cyclic question set comprising at least one sub-cyclic survey question;
determining a sub-survey-pulse rate corresponding to a plurality of sub-pulse periods, said sub-survey-pulse rate being no more than half as frequent as said base survey-pulse rate;
performing steps a and c during each current sub-pulse period of said plurality of sub-pulse periods:
c. performing sub-steps vii-xi for each current client entity of said multiplicity of client entities:
vii. selecting a sub-survey group comprising said at least one sub-cyclic survey question of said sub-cyclic question set;
viii. obtaining, from said plurality of respondents, a plurality of sub-cyclic survey responses corresponding to said at least one sub-cyclic survey question of said sub-survey group;
ix. determining an intra-entity benchmark sub-cyclic statistic corresponding to said plurality of obtained sub-cyclic survey responses;
x. determining an inter-entity benchmark sub-cyclic statistic corresponding to said plurality of obtained sub-cyclic survey responses and a plurality of other-entities responses to said at least one sub-cyclic survey question that were provided by a plurality of other-entities respondents associated with said benchmark group; and
xi. providing for presentation to each current client entity a sub-cyclic survey-results interface comprising said intra-entity benchmark sub-cyclic statistic, said inter-entity benchmark sub-cyclic statistic, and said plurality of obtained sub-cyclic survey responses, said plurality of obtained sub-cyclic survey responses being unattributable to said plurality of respondents.

3. The method of claim 1, further comprising:
obtaining a persistent question set comprising at least one persistent survey question that is posed during every pulse period; and
during each current base pulse period, further performing at least the following sub-steps for each current client entity of said multiplicity of client entities:
obtaining, from said plurality of respondents that are associated with each current client entity, a plurality of persistent-question responses corresponding to said at least one persistent survey question of said persistent question set.

4. The method of claim 3, wherein obtaining said persistent question set comprising said at least one persistent survey question comprises obtaining a survey question asking a respondent to indicate an individual for recognition.

5. The method of claim 4, further comprising:
during each current base pulse period, further performing at least the following sub-steps for each current client entity of said multiplicity of client entities:
identifying one or more individuals who were indicated for recognition according to said at least one persistent survey question; and
providing for presentation to each current client entity an individual-recognition interface recognizing said identified one or more individuals.

6. The method of claim 5, further comprising identifying one or more respondents of said plurality of respondents who respectively indicated said identified one or more individuals for recognition.

7. The method of claim 6, wherein said individual-recognition interface further identifies said identified one or more respondents as having respectively indicated said identified one or more individuals for recognition.

8. The method of claim 3, wherein obtaining said persistent question set comprising said at least one persistent survey question comprises obtaining a survey question asking a respondent to indicate a suggestion.

9. The method of claim 8, further comprising:
during each current base pulse period, further performing at least the following sub-steps for each current client entity of said multiplicity of client entities:
identifying one or more suggestions that were indicated according to said at least one persistent survey question;
identifying one or more respondents who respectively indicated said identified one or more suggestions; and
providing for presentation to each current client entity an indicated-suggestion interface indicating said identified one or more suggestions and correlating said identified one or more suggestions to corresponding responses of said plurality of obtained survey responses that were respectively provided by said identified one or more respondents.

10. The method of claim 1, wherein obtaining said plurality of obtained survey responses comprises obtaining, from some or all of said plurality of respondents, a plurality of comments corresponding to said at least one selected survey question of said survey group.

11. The method of claim 10, wherein providing said survey-results interface comprises providing a comments interface indicating said plurality of obtained comments and anonymously correlating said plurality of obtained comments to corresponding responses of said plurality of obtained survey responses that were respectively provided by said some or all of said plurality of respondents who provided said plurality of obtained comments.

12. The method of claim 10, wherein providing said survey-results interface comprises providing an anonymized-communication interface enabling anonymized communication with said some or all of said plurality of respondents who provided said plurality of obtained comments.

13. A computing apparatus for providing a pulsed-survey service, the apparatus comprising a processor and a memory storing instructions that, when executed by the processor, configure the apparatus to:
obtain a question sequence comprising at least ten survey questions;
determine a base survey-pulse rate corresponding to a plurality of base pulse periods, said base survey-pulse rate being no more frequent than one pulse period per day;
perform steps a-b during each current base pulse period of said plurality of base pulse periods:
a. identify a multiplicity of client entities that are subscribed to said pulsed-survey service during each current base pulse period;
b. perform sub-steps i-vi for each current client entity of said multiplicity of client entities:
i. determine a position within said question sequence for each current client entity;
ii. select a survey group comprising at least one survey question from said question sequence according to said determined position, but said survey group comprising no more than ten percent of said at least ten survey questions of said question sequence;
iii. obtain, from a plurality of respondents that are associated with each current client entity, a plurality of survey responses corresponding to said at least one selected survey question of said survey group;
iv. determine an intra-entity benchmark statistic corresponding to said plurality of obtained survey responses;
v. determine an inter-entity benchmark statistic corresponding to said plurality of obtained survey responses and a plurality of other-entities responses to said at least one selected survey question that were provided by a plurality of other-entities respondents associated with a benchmark group of other client entities that are similar in some respect to each current client entity; and
vi. provide for presentation to each current client entity a survey-results interface comprising said intra-entity benchmark statistic, said inter-entity benchmark statistic, and said plurality of obtained survey responses, said plurality of obtained survey responses being unattributable to said plurality of respondents.

14. The apparatus of claim 13, wherein the memory stores further instructions that further configure the apparatus to:
obtain a sub-cyclic question set comprising at least one sub-cyclic survey question;
determine a sub-survey-pulse rate corresponding to a plurality of sub-pulse periods, said sub-survey-pulse rate being no more than half as frequent as said base survey-pulse rate;
perform steps a and c during each current sub-pulse period of said plurality of sub-pulse periods:
c. perform sub-steps vii-xi for each current client entity of said multiplicity of client entities:
vii. select a sub-survey group comprising said at least one sub-cyclic survey question of said sub-cyclic question set;
viii. obtain, from said plurality of respondents, a plurality of sub-cyclic survey responses corresponding to said at least one sub-cyclic survey question of said sub-survey group;
ix. determine an intra-entity benchmark sub-cyclic statistic corresponding to said plurality of obtained sub-cyclic survey responses;
x. determine an inter-entity benchmark sub-cyclic statistic corresponding to said plurality of obtained sub-cyclic survey responses and a plurality of other-entities responses to said at least one sub-cyclic survey question that were provided by a plurality of other-entities respondents associated with said benchmark group; and
xi. provide for presentation to each current client entity a sub-cyclic survey-results interface comprising said intra-entity benchmark sub-cyclic statistic, said inter-entity benchmark sub-cyclic statistic, and said plurality of obtained sub-cyclic survey responses, said plurality of obtained sub-cyclic survey responses being unattributable to said plurality of respondents.

15. The apparatus of claim 13, wherein the memory stores further instructions that further configure the apparatus to:
obtain a persistent question set comprising at least one persistent survey question that is posed during every pulse period; and
during each current base pulse period, further perform at least the following sub-steps for each current client entity of said multiplicity of client entities:
obtain, from said plurality of respondents that are associated with each current client entity, a plurality of persistent-question responses corresponding to said at least one persistent survey question of said persistent question set.

16. The apparatus of claim 15, wherein the instructions that configure the apparatus to obtain said persistent question set comprising said at least one persistent survey question further comprise instructions configuring the apparatus to obtain a survey question asking a respondent to indicate an individual for recognition.

17. A non-transient computer-readable storage medium having stored thereon instructions that, when executed by a processor, configure the processor to:
obtain a question sequence comprising at least ten survey questions;
determine a base survey-pulse rate corresponding to a plurality of base pulse periods, said base survey-pulse rate being no more frequent than one pulse period per day;
perform steps a-b during each current base pulse period of said plurality of base pulse periods:
a. identify a multiplicity of client entities that are subscribed to a pulsed-survey service during each current base pulse period;
b. perform sub-steps i-vi for each current client entity of said multiplicity of client entities:
i. determine a position within said question sequence for each current client entity;
ii. select a survey group comprising at least one survey question from said question sequence according to said determined position, but said survey group comprising no more than ten percent of said at least ten survey questions of said question sequence;
iii. obtain, from a plurality of respondents that are associated with each current client entity, a plurality of survey responses corresponding to said at least one selected survey question of said survey group;
iv. determine an intra-entity benchmark statistic corresponding to said plurality of obtained survey responses;
v. determine an inter-entity benchmark statistic corresponding to said plurality of obtained survey responses and a plurality of other-entities responses to said at least one selected survey question that were provided by a plurality of other-entities respondents associated with a benchmark group of other client entities that are similar in some respect to each current client entity; and
vi. provide for presentation to each current client entity a survey-results interface comprising said intra-entity benchmark statistic, said inter-entity benchmark statistic, and said plurality of obtained survey responses, said plurality of obtained survey responses being unattributable to said plurality of respondents.

18. The storage medium of claim 17, having stored thereon further instructions that further configure the processor to:
obtain a sub-cyclic question set comprising at least one sub-cyclic survey question;
determine a sub-survey-pulse rate corresponding to a plurality of sub-pulse periods, said sub-survey-pulse rate being no more than half as frequent as said base survey-pulse rate;
perform steps a and c during each current sub-pulse period of said plurality of sub-pulse periods:
c. perform sub-steps vii-xi for each current client entity of said multiplicity of client entities:
vii. select a sub-survey group comprising said at least one sub-cyclic survey question of said sub-cyclic question set;
viii. obtain, from said plurality of respondents, a plurality of sub-cyclic survey responses corresponding to said at least one sub-cyclic survey question of said sub-survey group;
ix. determine an intra-entity benchmark sub-cyclic statistic corresponding to said plurality of obtained sub-cyclic survey responses;
x. determine an inter-entity benchmark sub-cyclic statistic corresponding to said plurality of obtained sub-cyclic survey responses and a plurality of other-entities responses to said at least one sub-cyclic survey question that were provided by a plurality of other-entities respondents associated with said benchmark group; and
xi. provide for presentation to each current client entity a sub-cyclic survey-results interface comprising said intra-entity benchmark sub-cyclic statistic, said inter-entity benchmark sub-cyclic statistic, and said plurality of obtained sub-cyclic survey responses, said plurality of obtained sub-cyclic survey responses being unattributable to said plurality of respondents.

19. The storage medium of claim 17, having stored thereon further instructions that further configure the processor to:
obtain a persistent question set comprising at least one persistent survey question that is posed during every pulse period; and
during each current base pulse period, further perform at least the following sub-steps for each current client entity of said multiplicity of client entities:
obtain, from said plurality of respondents that are associated with each current client entity, a plurality of persistent-question responses corresponding to said at least one persistent survey question of said persistent question set.

20. The storage medium of claim 19, wherein the instructions that configure the processor to obtain said persistent question set comprising said at least one persistent survey question further comprise instructions configuring the processor to obtain a survey question asking a respondent to indicate an individual for recognition.
